(19) United States
(12) Patent Application Publication
(10) Pub. No.: US 2026/0003174 A1
(43) Pub. Date: Jan. 1, 2026

(54) STATIC RELAY OPTICAL ASSEMBLY FOR PANNING OPTICAL SYSTEM

(71) Applicant: VIAVI Solutions Inc., Chandler, AZ (US)

(72) Inventors: Kevin CASSADY, Monroe, WA (US); Abhilash SUKUMARI, Nepean (CA)

(21) Appl. No.: 18/758,932

(22) Filed: Jun. 28, 2024

(51) Int. Cl. G02B 21/00; G01M 11/00; G02B 21/36

(52) U.S. Cl. CPC G02B 21/0036; G01M 11/31; G02B 21/361

(57) ABSTRACT

In some implementations, an optical system includes a scope assembly, comprising: a scope with a first field of view of a first size; a movable element to move the first field of view of the scope across a range of positions corresponding to a fiber optic connector endface of a second size, wherein the first size is smaller than the second size; and a relay optical assembly, comprising: a set of relay optics to direct light between a first position and a second position, wherein the set of relay optics is associated with a second field of view of the second size, and wherein the relay optical assembly is movably coupled to the scope assembly, such that a movement of the scope in connection with the movable element does not move the set of relay optics.

### BACKGROUND

A scope, such as a microscope, may be used to view or image an object or other target. For example, a microscope and camera may image an object, which may enable analysis of the object. The scope may have a fixed field of view, which may have a particular size. For example, for an object positioned a particular distance away from an end of the scope, the scope may have an image radius of a particular amount at the particular distance. When an object is larger than the field of view of the scope (e.g., the object is larger than the image radius at the particular distance), the scope may be moved in order to capture an entirety of the object.

### SUMMARY

In some implementations, an optical system includes a scope assembly, comprising: a scope with a first field of view of a first size; a movable element to move the first field of view of the scope across a range of positions corresponding to an object of a second size, wherein the first size is smaller than the second size; and a relay optical assembly, comprising: a set of relay optics to direct light between a first position and a second position, wherein the set of relay optics is associated with a second field of view of the second size, and wherein the relay optical assembly is movably coupled to the scope assembly, such that a movement of the scope in connection with the movable element does not move the set of relay optics.

In some implementations, a coupling element includes a first end to receive a scope assembly, comprising: a scope with a first field of view of a first size; a movable element to move the first field of view of the scope across a range of positions corresponding to an object of a second size, wherein the first size is smaller than the second size; and a second end to receive a relay optical assembly, comprising: a set of relay optics to direct light between a first position and a second position, wherein the set of relay optics is associated with a second field of view of the second size, and wherein the coupling element couples the scope assembly to the set of relay optics, such that the set of relay optics is static and the scope is movable.

In some implementations, a relay optic includes a first end to receive a scope assembly, comprising: a scope with a first field of view of a first size; a movable element to move the first field of view of the scope across a range of positions corresponding to an object of a second size, wherein the first size is smaller than the second size; a second end with a second field of view of the second size; and a body comprising a set of optical elements, wherein the set of optical elements is configured to direct light between the first end and the second end, wherein the set of optical elements is associated with a second field of view of the second size, and wherein the first end is movably coupled to the scope assembly.

### BRIEF DESCRIPTION OF THE DRAWINGS

FIG. 1 shows an example of a microscope for imaging an object.

FIG. 2 shows an example of an optical system for imaging an object.

FIGS. 3A and 3B are diagrams of an example implementation associated with a static relay optical assembly for a panning optical system.

### DETAILED DESCRIPTION

The following detailed description of example implementations refers to the accompanying drawings. The same reference numbers in different drawings may identify the same or similar elements. The following description uses a spectrometer or a microscope as an example. However, the techniques, principles, procedures, and methods described herein may be used with any sensor, including but not limited to other optical sensors and spectral sensors.

A scope, such as a microscope or a spectroscope, may be used to capture an image of a target, such as an object. For example, in a fiber testing scenario, a scope may capture images of a set of fiber ends of a fiber ribbon cable. The scope may provide the images to a computing device, which may analyze the images to determine whether any defects are detected in the set of fiber ends. The scope may have a fixed field of view, such as a field of view of a particular radius at a particular distance with which the scope is configured to image an object.

If the object is larger than the field of view at the particular distance, the scope may be moved further away from the object to widen the radius of the field of view. However, this may result in a loss of resolution of the imaging of the object as a result of the increased distance between the object and the scope (and associated camera). Additionally, moving an object farther from the scope to increase an amount of the object that can be imaged within a fixed field of view of the microscope may result in decreased depth of field or optical distortion. Furthermore, some objects and/or scopes may be in a position such that moving the object farther from the scopes may not be possible (e.g., a physical space in which imaging is to occur does not accommodate moving the scope farther from an object).

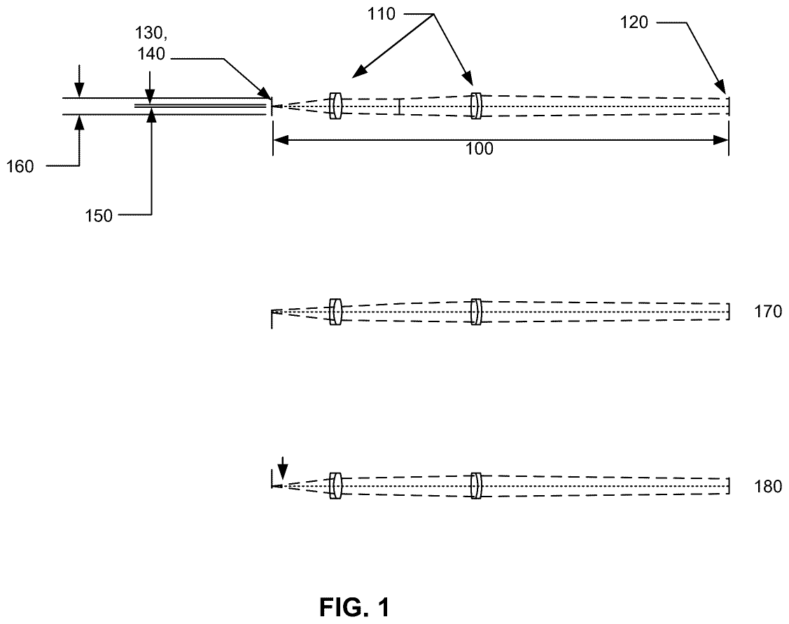

FIG. 1 shows an example of a microscope 100 for imaging an object. As shown in FIG. 1, the microscope 100 may include a set of optics 110 and may be associated with a camera 120. The set of optics 110 may convey light to form an image of an object 130 (e.g., a fiber optic connector endface), which is positioned at a position 140. The set of optics 110 may be associated with a field of view 150. As shown by reference number 160, the object 130 is associated with a size that is larger than the field of view 150. Accordingly, as shown by reference numbers 170 and 180, to accommodate an object 130 that does not fit within the field of view 150 of the microscope 100 at the position 140, the microscope 100 may move laterally relative to the object 130. For example, as shown in reference number 170, the microscope 100 may start at a top of the object 130 and, as shown by reference number 180, the microscope 100 may pan downward toward the bottom of the object 130. In other words, the microscope 100 and camera 120 may pan and capture a set of images of the object 130 from a set of different vertical positions. In such an example, the set of images may be stitched together or analyzed separately to analyze an entirety of an object 130. For example, when the object 130 is a fiber end of a fiber ribbon cable, the set of images may be a set of images of each fiber end of the fiber ribbon cable. A computing device (not shown) may receive the set of images of each fiber end and determine whether any of the fiber ends is associated with a defect. Some microscopes 100 may have internal movement mechanisms to pan or tilt relative to the object 130 (e.g., and within and relative to a fixed housing), thereby obviating a need for a user to manually adjust the scope.

As indicated above, FIG. 1 is provided as an example. Other examples may differ from what is described with regard to FIG. 1.

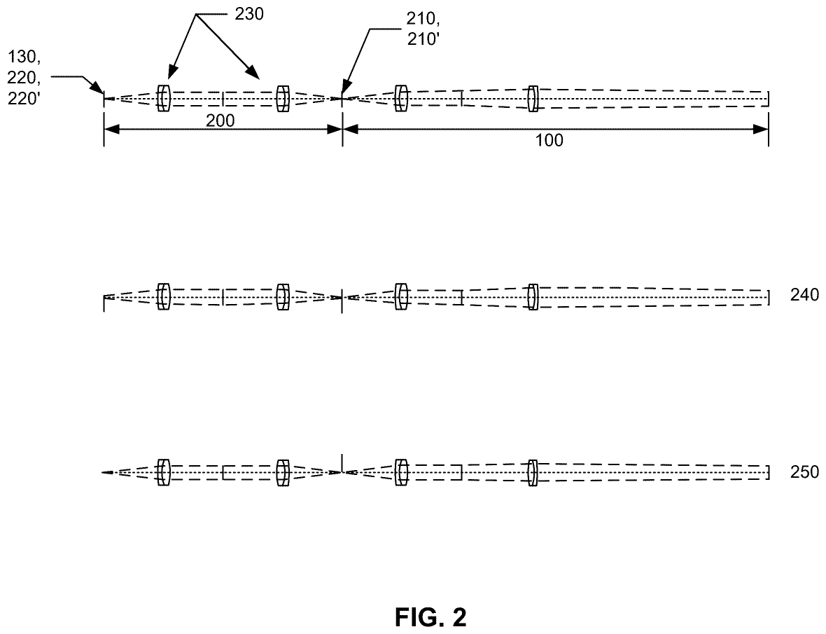

FIG. 2 shows an example of an optical system for imaging an object. As shown in FIG. 2, the microscope 100 may be attached to a relay optic assembly 200. For example, when the object 130 is at a position that is inconvenient for the microscope 100 to view (e.g., there are physical limitations on positioning the microscope 100 relative to the object 130), the relay optic assembly 200 can be attached to the microscope 100 to enable the microscope 100 to image the object 130 from a greater distance without causing a loss of resolution, decreased depth of field, or distortion. Furthermore, the relay optic assembly 200 may add flexibility to the microscope 100, such as by having an end configured to receive the object 130 and hold the object 130 in a fixed position, or having a flexible body that can be repositioned without damaging the set of optics 110, among other examples. The relay optic assembly 200 may include a first end 210 to attach to the microscope 100 at an intermediate image plane 210′, a second end 220 at which the object 130 is positioned at a position 220′, and a set of relay optics 230 to convey light between the intermediate image plane 210′ and the position 220′. As shown by reference numbers 240 and 250, to perform imaging of an object 130 that is larger than the field of view of the microscope 100, the microscope 100 and the relay optic assembly 200 may be moved relative to the object 130. For example, a panning mechanism may pan the microscope 100 and the relay optic assembly 200 from a top of the object 130, as shown by reference number 240, to a bottom of the object 130, as shown by reference number 250.

However, in some examples, a relay optic assembly 200 may be relatively long, to bridge a large gap between an intermediate image plane 210′ and a position 220′. In such cases, mounting the relay optic assembly 200 to the microscope 100 so that both the microscope 100 and the relay optic assembly 200 can move together may result in a lack of robustness in a mechanical assembly. Furthermore, when a microscope 100 includes both a dynamic portion that moves (e.g., the set of optics 110) and a static portion that is fixed (e.g., a housing), attaching the relay optic assembly to the dynamic portion may be difficult (e.g., may require opening the housing to access the dynamic portion within an opening of the housing). This may result in poor attachment, damage to the microscope 100, or delay in configuring the microscope 100 for imaging (and delay for manufacturing that requires testing using the imaging).

As indicated above, FIG. 2 is provided as an example. Other examples may differ from what is described with regard to FIG. 2.

Some implementations described herein provide an optical system in which a relay optical assembly is static relative to a scope assembly. For example, a relay optical assembly may attach to a static portion of a microscope rather than a dynamic portion of the microscope. In this case, the dynamic portion of the microscope moves relative to the relay optical assembly rather than moving with the relay optical assembly. To accommodate objects (e.g., fiber optic connector endfaces) larger than a field of view of a scope assembly, the relay optical assembly may be selected to have a larger field of view than the scope assembly (and large enough to accommodate an entirety of an object that is a target of imaging). Accordingly, when the scope assembly is panned or otherwise moved to capture images of an object that is larger than a field of view of the scope assembly, the scope assembly pans, is panned, or is otherwise moved within a fixed field of view of the relay optical assembly. In this way, by fixing the relay optical assembly relative to the object (and relative to a static portion of the scope assembly, but not relative to a dynamic portion of the scope assembly), a robustness of a mechanical connection between the relay optical assembly and the scope assembly may be improved. Moreover, the relay optical assembly may be attached to a housing of the scope assembly, thereby obviating a need to attach the relay optical assembly within an opening of the housing. This reduces a likelihood of damage to the scope assembly and increases a speed with which the relay optical assembly may be attached and inspection may be performed.

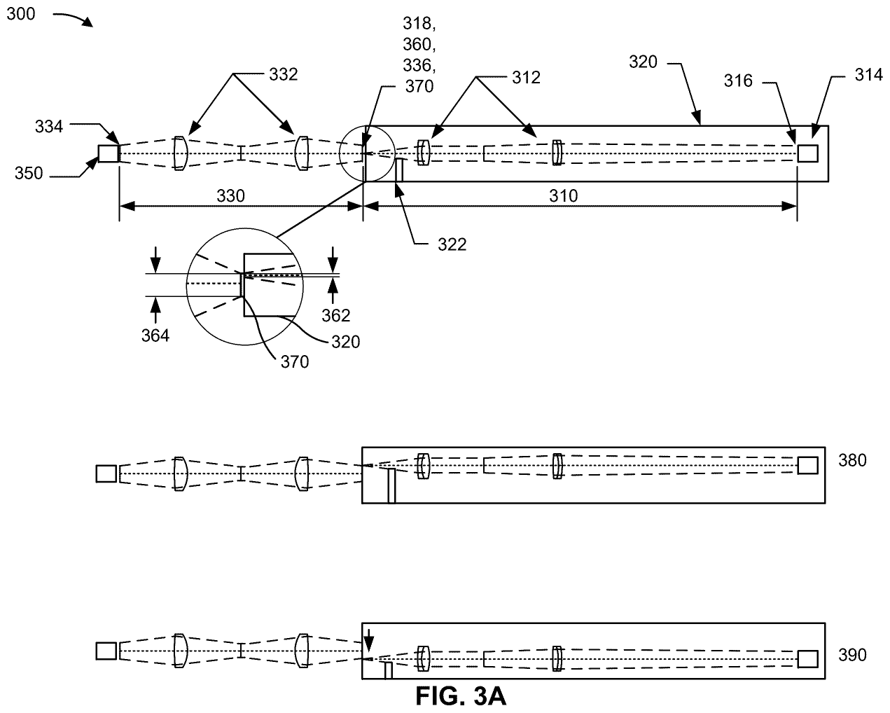

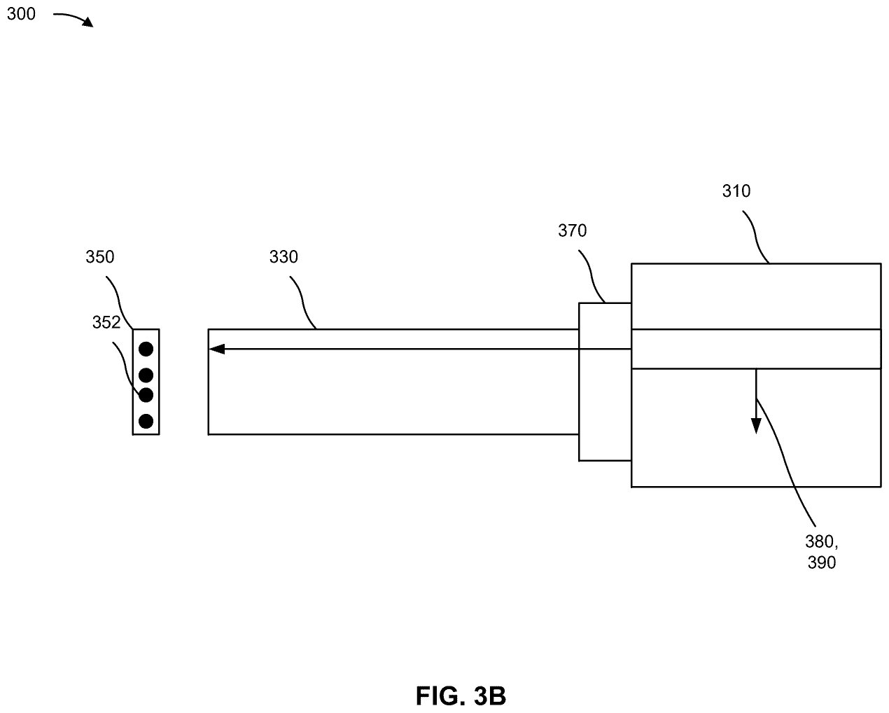

FIGS. 3A and 3B are diagrams of an example implementation 300 associated with a static relay optical assembly for a panning optical system. FIG. 3A shows an optical layout of the example implementation 300, and FIG. 3B shows a physical layout of the example implementation 300. As shown in FIGS. 3A and 3B, example implementation 300 includes a scope assembly 310 and a relay optical assembly 330 for performing imaging or other detection of an object 350 (e.g., a fiber optic connector, fiber optic connector endface, or another type of object). In some implementations, the scope assembly 350 may be an inspection component for testing or inspecting fiber optic connectors.

The scope assembly 310 may include a scope formed from a set of scope optics 312. For example, the scope assembly 310 may include a set of refractive types of scope optics 312, such as a set of lenses, a set of refractive gratings, a set of refractive prisms, or a set of refractive beam expanders, among other examples. Additionally, or alternatively, the scope assembly 310 may include a set of reflective types of scope optics 312, such as a set of mirrors, a set of reflective gratings, a set of reflective prisms, or a set of reflective beam expanders, among other examples. In some implementations, the scope assembly 310 may have a combination of reflective scope optics 312 and refractive scope optics 312. In some implementations, the scope assembly 310 and the set of scope optics 312 may be configured for a particular type of sensing. For example, the scope assembly 310 may form a microscope, a spectroscope, or another type of scope.

In some implementations, the scope assembly 310 may include a receiver element 314, such as a camera element, a photodiode element, or another type of detector element. For example, the scope assembly 310 may include a first end 316 to which light is directed for imaging (or other detection) of an object. Additionally, or alternatively, the scope assembly 310 may include a second end 318 at which the relay optical assembly 330 is connected to the scope assembly 310. In some implementations, the scope assembly 310 includes a housing 320. For example, the scope assembly 310 may include a static housing, to which the relay optical assembly 330 is attached, as described in more details herein.

In some implementations, the scope assembly 310 includes a movable element 322. For example, the scope assembly 310 may include a mechanism for effectuating a panning operation, a tilting operation, or a translating operation, among other examples, on at least a portion of the scope assembly 310. The movable element 322 may move the set of scope optics 312 and the receiver element 314 relative to the (static) housing 320, the (static) relay optical assembly 330, and the (static) object 350. For example, the movable element 322 may use a piezoelectric actuator, a galvanometer actuator (e.g., a galvanometer mirror (“galvo mirror”)), an electromagnetic coil, a pneumatic or hydraulic actuator, a linear motor, a micro-stepping motor (“micro-stepper”), or a micro-electromechanical system (MEMS) device (e.g., a MEMS actuator or a MEMS mirror), among other examples.

The relay optical assembly 330 may be a coupling element that optically and/or physically couples the object 350 to the scope assembly 310. For example, the relay optical assembly 330 may form a two-way optical path for directing light or a beam between the scope assembly 310 and the object 350. In some implementations, the relay optical assembly 330 may include an optical relay formed from a set of relay optics 332. For example, the relay optical assembly 330 may include a set of refractive type of relay optics 332, such as a set of lenses, a set of refractive gratings, a set of refractive prisms, or a set of refractive beam expanders, among other examples. Additionally, or alternatively, the relay optical assembly 330 may include a set of reflective type of relay optics 332, such as a set of mirrors, a set of reflective gratings, a set of reflective prisms, or a set of reflective beam expanders, among other examples. In some implementations, the relay optical assembly 330 may have a combination of reflective relay optics 332 and refractive relay optics 332.

In some implementations, the relay optical assembly 330 may be associated with creating a field of view on an intermediate image plane 360. For example, the relay optical assembly 330 may include a first end 334 that receives the object 350 and a second end 336 that receives and is matched to the second end 318 of the scope assembly 310. The first end 334 may include an adapter or end piece configured to hold the object 350 in place. For example, the first end 334 may include a fiber coupler to receive an optical ribbon fiber cable type object 350 for inspection of fiber ends 352 of the optical ribbon fiber cable type object 350. Although some implementations are described herein in terms of an object 350, which may be a fiber ribbon cable, other types of targets for imaging or spectroscopy may be used.

The second end 336 may be associated with a coupling element 370. The coupling element 370 may be a portion of the scope assembly 310, a portion of the relay optical assembly 330, or a separate structure. For example, the coupling element 370 may statically attach the relay optical assembly 330 to the housing 320 of the scope assembly 310. In this case, the set of scope optics 312, for example, move within the housing 320 without the relay optical assembly 330 moving. In some implementations, the relay optical assembly 330 may be included within a housing (not shown) that couples to the housing 320 of the scope assembly 310 (e.g., via the coupling element 370). In some implementations, the coupling element 370 may be a portion of the housing 320 (e.g., an opening or another structure to which the relay optical assembly 330 can attach). By maintaining the relay optical assembly 330 in a fixed or static position attached to the housing 320, a robustness of the connection between the relay optical assembly 330 and the scope assembly 310 is improved, relative to having a relay optical assembly that moves with the set of scope optics. Moreover, by maintaining the relay optical assembly 330 in a fixed or static position relative to the object 350, a likelihood of damaging the object 350 during movement for imaging, and a difficulty of aligning the relay optical assembly 330 to the object 350, are reduced relative to other configurations in which a relay optical assembly moves relative to the object 350 during imaging.

In some implementations, the scope assembly 310 is associated with a first field of view 362 at the intermediate image plane 360 and the relay optical assembly 330 is associated with a second field of view 364, which is larger than the first field of view 362, at the intermediate image plane 360. Accordingly, the movable element 322 may move a dynamic portion of the scope assembly 310 (e.g., the set of scope optics 312 and the receiver element 314) to move the first field of view 362 from a first location to a second location to cover the entirety of the second field of view 364, as shown by reference numbers 380 and 390. In other words, the movable element pans the dynamic portion of scope assembly 310 to image an entirety of the object 350 at the intermediate image plane 360 without the relay optical assembly 330 moving (e.g., the relay optical assembly 330 projects the entirety of the object 350 at the intermediate image plane 360). Accordingly, the relay optical assembly 330, which is attached to the scope assembly 310 to enable imaging of the object 350, may be selected based on a size of the object 350, such that an entirety of the object 350 (or an entirety of the object 350 that is to be imaged) can fit within the second field of view 364 of the relay optical assembly 330. Because manufacturing different size relay optical assemblies 330 can be less expensive and use less resources (e.g., fewer optics, no receiver element, etc.) than manufacturing different size scope assemblies 310, using different relay optical assemblies 330 for different size objects 350 may reduce cost and reduce resource utilization while increasing a flexibility for inspection using fixed field of view size scope assemblies 310.

As indicated above, FIGS. 3A and 3B are provided as an example. Other examples may differ from what is described with regard to FIGS. 3A and 3B.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An optical system, comprising:
a scope assembly, comprising:
a scope with a first field of view of a first size;
a movable element to move the first field of view of the scope across a range of positions corresponding to a fiber optic connector endface of a second size,
wherein the first size is smaller than the second size; and
a relay optical assembly, comprising:
a set of relay optics to direct light between a first position and a second position,
wherein the set of relay optics is associated with a second field of view of the second size, and
wherein the relay optical assembly is movably coupled to the scope assembly, such that a movement of the scope in connection with the movable element does not move the set of relay optics.

2. The optical system of claim 1, further comprising:
a camera element statically coupled to the scope assembly, such that the movement of the scope in connection with the movable element moves the camera element.

3. The optical system of claim 1, wherein the scope assembly includes a set of scope optics.

4. The optical system of claim 3, wherein the set of scope optics includes at least one of: a refractive optic or a reflective optic.

5. The optical system of claim 1, wherein the set of relay optics includes at least one of: a refractive optic or a reflective optic.

6. The optical system of claim 1, wherein the scope includes at least one of a microscope or a spectroscope.

7. The optical system of claim 1, wherein the relay optical assembly forms a two-way optical path for directing a beam toward the fiber optic connector endface and receiving a reflection of the beam from the fiber optic connector endface.

8. The optical system of claim 1, further comprising:
a coupling element to couple the scope assembly to the relay optical assembly,
wherein the relay optical assembly is fixed relative to the coupling element, and
wherein the scope is movable relative to the coupling element.

9. The optical system of claim 1, wherein the movable element is configured to effectuate, on the scope, at least one of:
a panning operation,
a tilting operation, or
a translating operation.

10. The optical system of claim 1, wherein the relay optical assembly includes an end piece for receiving the fiber optic connector endface.

11. A coupling element, comprising:
a first end to receive a scope assembly, comprising:
a scope with a first field of view of a first size;
a movable element to move the first field of view of the scope across a range of positions corresponding to an object of a second size,
wherein the first size is smaller than the second size; and
a second end to receive a relay optical assembly, comprising:
a set of relay optics to direct light between a first position and a second position,
wherein the set of relay optics is associated with a second field of view of the second size, and
wherein the coupling element couples the scope assembly to the set of relay optics, such that the set of relay optics is static and the scope is movable.

12. The coupling element of claim 11, wherein the scope includes at least one of a microscope or a spectroscope.

13. The coupling element of claim 11, wherein the relay optical assembly forms a two-way optical path for directing a beam toward the object and receiving a reflection of the beam from the object.

14. The coupling element of claim 11, wherein the movable element is configured to effectuate, on the scope, at least one of:
a panning operation,
a tilting operation, or
a translating operation.

15. The coupling element of claim 11, wherein the scope assembly includes a camera element statically coupled to the scope assembly, such that movement of the scope in connection with the movable element moves the camera element.

16. The coupling element of claim 11, wherein the scope includes a set of scope optics.

17. The coupling element of claim 16, wherein the set of scope optics includes at least one of: a refractive optic or a reflective optic.

18. A relay optic, comprising:
a first end to receive a scope assembly, comprising:
a scope with a first field of view of a first size;
a movable element to move the first field of view of the scope across a range of positions corresponding to fiber connector of a second size,
wherein the first size is smaller than the second size;
a second end with a second field of view of the second size; and
a body comprising a set of optical elements,
wherein the set of optical elements is configured to direct light between the first end and the second end,
wherein the set of optical elements is associated with a second field of view of the second size, and
wherein the first end is movably coupled to the scope assembly.

19. The relay optic of claim 18, wherein the set of optical elements includes at least one of: a refractive optic or a reflective optic.

20. The relay optic of claim 18, wherein the second end is configured to receive an optical ribbon fiber.
